(19) United States
(12) Patent Application Publication
(10) Pub. No.: US 2024/0072288 A1
(43) Pub. Date: Feb. 29, 2024

(54) FUEL CELL SYSTEM

(71) Applicant: HONDA MOTOR CO., LTD., Minato-ku, Tokyo (JP)

(72) Inventor: Yuhei HORIUCHI, WAKO-SHI, SAITAMA-KEN (JP)

(21) Appl. No.: 18/236,043

(22) Filed: Aug. 21, 2023

(30) Foreign Application Priority Data
Aug. 26, 2022 (JP) 2022-134732

(51) Int. Cl. H01M 8/2475; H01M 8/0273; H01M 8/04082; H01M 8/04119

(52) U.S. Cl. CPC H01M 8/2475; H01M 8/0273; H01M 8/04126; H01M 8/04201

(57) ABSTRACT

The fuel cell system includes a fuel cell stack and a predetermined device. A gas receiving portion for receiving an exhaust gas from the fuel cell stack is formed in the predetermined device. The gas outlets of the fuel cell stack and the gas receiving portion are connected via a pipe. An upstream portion of a joint tube made of an insulator is inserted into a downstream opening of the pipe. The joint tube has a hollow protrusion with a smaller outer diameter than the upstream portion. The hollow protrusion protrudes upstream (inside the pipe) from the upstream portion in the flow direction of the exhaust gas.

### CROSS-REFERENCE TO RELATED APPLICATIONS

This application is based upon and claims the benefit of priority from Japanese Patent Application No. 2022-134732 filed on Aug. 26, 2022, the contents of which are incorporated herein by reference.

### BACKGROUND OF THE INVENTION

### Field of the Invention

The present invention relates to a fuel cell system including a fuel cell stack.

### Description of the Related Art

In recent years, research and development have been conducted on fuel cells that contribute to energy efficiency in order to ensure that more people have access to affordable, reliable, sustainable and modern energy. Further, in order to reduce the burden on the global environment, the vehicle emissions control has been more stringent. In view of the above, attempts have been made to mount a fuel cell system instead of an internal combustion engine in a moving object such as an automobile. This is because CO₂, SOₓ, NOₓ, and the like are not discharged from the fuel cell system.

The fuel cell system includes a fuel cell stack in which a plurality of unit cells are stacked. For operating the fuel cell stack, a fuel gas is supplied to anodes of the unit cells, and an oxygen-containing gas is supplied to cathodes of the unit cells. At the cathodes, water is produced by electrode reactions. The produced water is discharged from the cathodes along with the oxygen-containing gas that has not been used in the electrode reactions. Hereinafter, the oxygen-containing gas discharged from the cathodes without being used in the electrode reactions is referred to as a cathode off-gas.

The cathode off-gas is sent to a humidifier as described in JP 2017-079158 A, for example. A porous membrane is provided inside the humidifier. The produced water in the cathode off-gas is separated from the oxygen-containing gas by the porous membrane. The oxygen-containing gas to be newly supplied to the cathodes flows through the humidifier. The produced water separated from the cathode off-gas is given to the oxygen-containing gas. The oxygen-containing gas thus humidified by the produced water is then supplied from the humidifier to the cathodes.

### SUMMARY OF THE INVENTION

Separators forming the unit cell are conductors. The material of a casing of the humidifier is typically metal. In other words, the casing is also a conductor. Since the produced water contains conductive ions eluted from the unit cells, the produced water is also a conductor. Therefore, if there is continuous stream of the produced water formed from the fuel cell stack to the humidifier, it is possible for electric current to flow from the fuel cell stack to the humidifier through the produced water. If the fuel cell system is installed in an automobile, it is also possible for electric current to further flow into the vehicle body of the automobile.

Therefore, it is necessary to prevent the fuel cell stack and the humidifier from being electrically connected to each other through the produced water.

An object of the present invention is to solve the aforementioned problem.

According to an embodiment of the present invention, there is provided a fuel cell system including: a fuel cell stack, a device into which an exhaust gas discharged from the fuel cell stack flows, and a pipe connecting the fuel cell stack to the device, wherein the fuel cell stack includes a gas outlet from which the exhaust gas flows out, the device includes a gas receiving portion configured to receive the exhaust gas, the pipe extends from the gas outlet toward the gas receiving portion, a joint tube formed of an insulator is interposed between the pipe and the gas receiving portion, the joint tube has an upstream end portion inserted into a downstream opening of the pipe, a seal member is interposed between the joint tube and the pipe and configured to seal a gap between the upstream end portion of the joint tube and an inner wall of the pipe, the joint tube includes a hollow protrusion protruding upstream from the upstream end portion in a flow direction of the exhaust gas and having an outer diameter smaller than an outer diameter of the upstream end portion.

In the present invention, the hollow protrusion which is a part of the joint tube protrudes from the upstream end portion which is also a part of the joint tube. Here, a seal member that seals a space between an outer wall of the upstream end portion and an inner wall of the pipe is provided between the joint tube and the pipe. That is, the outer wall of the upstream end portion abuts against the inner wall of the pipe via the seal member. On the other hand, the outer diameter of the hollow protrusion is smaller than the outer diameter of the upstream end portion. Thus, the outer wall of the hollow protrusion is spaced apart from the inner wall of the pipe. Thus, a pocket is formed between the inner wall of the pipe and the outer wall of the hollow protrusion.

The water (liquid water) in the pipe generally flows along the inner wall of the pipe in a state of continuous stream in a stripe shape or a streak shape. The water flowing in the pipe is blown off from the pipe by the exhaust gas and enters the inside of the hollow protrusion from the inner wall of the pipe in a state of droplets. Alternatively, after entering the pocket, the water is blown away from the end of the outer wall of the hollow protrusion by the exhaust gas. Also at this time, the water enters the inside of the hollow protrusion in the form of droplets. Here, the “droplet” includes mist.

That is, the water entering the inside of the joint tube is separated from the water in the pipe. Therefore, the water in the pipe and the water entering the inside of the joint tube are electrically insulated from each other. The joint tube is an electrical insulator.

For the reasons described above, the fuel cell stack and the predetermined device are prevented from being electrically connected to each other through water. In other words, it is possible to prevent electric current from flowing from the fuel cell stack to the device. When the fuel cell system is mounted on a vehicle body of an automobile, electric current is prevented from flowing through the vehicle body.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic system diagram of a fuel cell system;

FIG. 2 is a schematic side cross-sectional view of a joint portion between an outlet of cathode off-gas in a fuel cell stack and an inlet of cathode off-gas in a device (humidifier);

FIG. 3 is an enlarged view of a principal part shown in FIG. 2; and

FIG. 4 is a partial cross-sectional view taken along line IV-IV in FIG. 3.

### DETAILED DESCRIPTION OF THE INVENTION

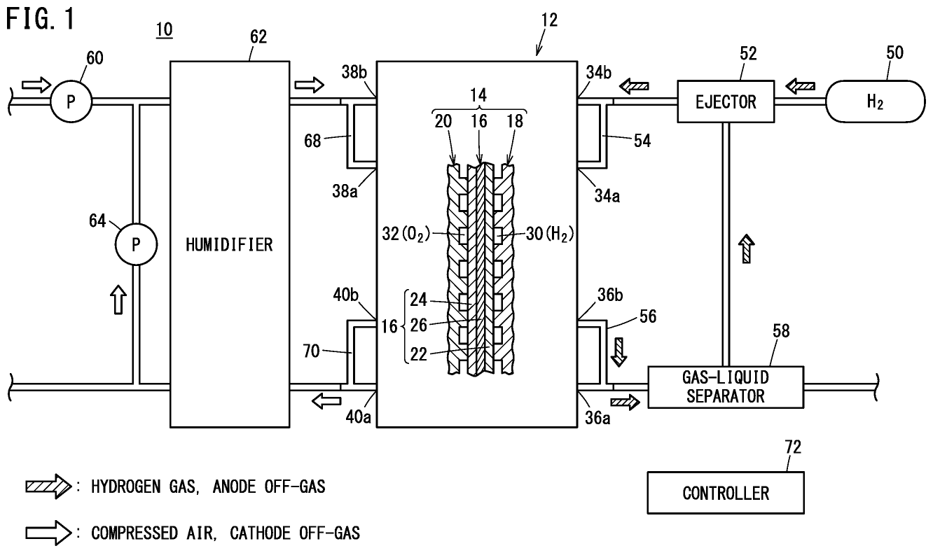

In the following description, a fuel gas that has not been used in power generation and discharged from an anode 22 of a fuel cell stack 12 shown in FIG. 1 is referred to as an anode off-gas. An oxygen-containing gas that has not been used in power generation and discharged from a cathode 24 of the fuel cell stack 12 is referred to as a cathode off-gas. “Upstream” and “downstream” represent upstream and downstream in the flow direction of the cathode off-gas, respectively.

First, a fuel cell system 10 shown in FIG. 1 will be described. FIG. 1 is simplified in order to facilitate understanding of the flows of the fuel gas and the oxygen-containing gas. Therefore, the directions shown in FIG. 1 do not necessarily coincide with the directions in the actual fuel cell system 10. In FIG. 1, a valve, a bypass line, and the like are omitted.

The fuel cell system 10 includes the fuel cell stack 12. A plurality of unit cells 14 are stacked in the fuel cell stack 12. The unit cell 14 is formed by sandwiching a membrane electrode assembly (MEA) 16 between a first separator 18 and a second separator 20. The MEA 16 is formed by sandwiching an electrolyte membrane 26 between the anode 22 and the cathode 24. The material of the first separator 18 and the second separator 20 is, for example, metal. The material of the electrolyte membrane 26 is, for example, a solid polymer such as perfluorosulfonic acid containing water.

A first gas flow field 30 is formed in the first separator 18. A hydrogen-containing gas (fuel gas) to be supplied to the anode 22 flows through the first gas flow field 30. A second gas flow field 32 is formed in the second separator 20. Compressed air (oxygen-containing gas) to be supplied to the cathode 24 flows through the second gas flow field 32. Between the unit cells 14 adjacent to each other, a coolant flow field (not shown) is formed by the first separator 18 of one unit cell 14 and the second separator 20 of the other unit cell 14. A coolant flows through the coolant flow field.

The fuel cell stack 12 includes a first hydrogen inlet 34a, a second hydrogen inlet 34b, a first hydrogen outlet 36a, and a second hydrogen outlet 36b. The fuel cell stack 12 is provided with a first air inlet 38a, a second air inlet 38b, a first air outlet 40a, and a second air outlet 40b. In other words, the fuel cell stack 12 has two hydrogen gas inlets and two hydrogen gas outlets. Similarly, there are two compressed air inlets and two compressed air outlets. There may be a single hydrogen inlet and a single air inlet.

The first hydrogen inlet 34a and the second hydrogen inlet 34b are connected to an inlet of the first gas flow field 30. An outlet of the first gas flow field 30 is connected to the first hydrogen outlet 36a and the second hydrogen outlet 36b. The first air inlet 38a and the second air inlet 38b are connected to an inlet of the second gas flow field 32. An outlet of the second gas flow field 32 is connected to the first air outlet 40a and the second air outlet 40b.

The fuel cell system 10 includes a high pressure tank 50 and an ejector 52. The high pressure tank 50 is filled with hydrogen gas. The ejector 52 is a device for supplying the hydrogen gas to the anode 22. A first supply manifold 54 is provided between the ejector 52 and the fuel cell stack 12. The first supply manifold 54 distributes the hydrogen gas supplied from the ejector 52 in two directions. The hydrogen gas distributed in one direction flows to the first hydrogen inlet 34a. The hydrogen gas distributed in the remaining one direction flows to the second hydrogen inlet 34b.

A gas-liquid separator 58 is connected to the fuel cell stack 12 via a first exhaust manifold 56. The anode off-gas discharged from each of the first hydrogen outlet 36a and the second hydrogen outlet 36b is collected in the first exhaust manifold 56 and sent to the gas-liquid separator 58. The anode off-gas is separated into hydrogen gas and water in the gas-liquid separator 58. The hydrogen gas thus separated is returned to the ejector 52 and then resupplied to the anode 22.

The fuel cell system 10 further includes an air pump 60, a humidifier 62, and a circulation pump 64. For example, the air pump 60 compresses the air to generate compressed air. The fuel cell stack 12 and the humidifier 62 are connected via a second supply manifold 68 and a second exhaust manifold 70. In the humidifier 62, water produced during power generation of the fuel cell stack 12 (produced water PW described later) is supplied to the compressed air provided by the air pump 60. As a result, the compressed air becomes humidified. The compressed air thus humidified is distributed in two directions by the second supply manifold 68. The compressed air distributed in one direction flows to the first air inlet 38a. The compressed air distributed in the remaining one direction flows to the second air inlet 38b. The circulation pump 64 may be omitted.

The cathode off-gas discharged from each of the first air outlet 40a and the second air outlet 40b join together in the second exhaust manifold 70 and flow to the humidifier 62. The produced water in the cathode off-gas is separated from the compressed air in the humidifier 62. The compressed air is resupplied to the cathode 24 by, for example, the circulation pump 64. On the other hand, the water content is added to fresh compressed air from the air pump 60 as described above.

The fuel cell system 10 is controlled by a controller 72. The fuel cell system 10 configured as described above is mounted on, for example, a body of an automobile.

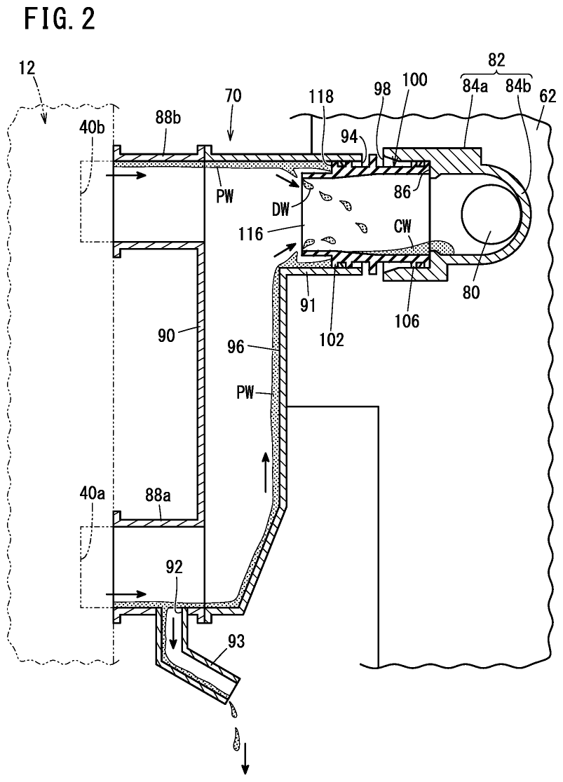

FIG. 2 is a schematic side cross-sectional view of a joint portion between an outlet of the cathode off-gas in the fuel cell stack 12 and an inlet of the cathode off-gas in the humidifier 62. As described above, the fuel cell system 10 includes the second exhaust manifold 70 that connects the fuel cell stack 12 and the humidifier 62. The humidifier 62 corresponds to a device that is connected downstream of the fuel cell stack 12 in the flow direction of the cathode off-gas discharged from the fuel cell stack 12. The second exhaust manifold 70 corresponds to a pipe.

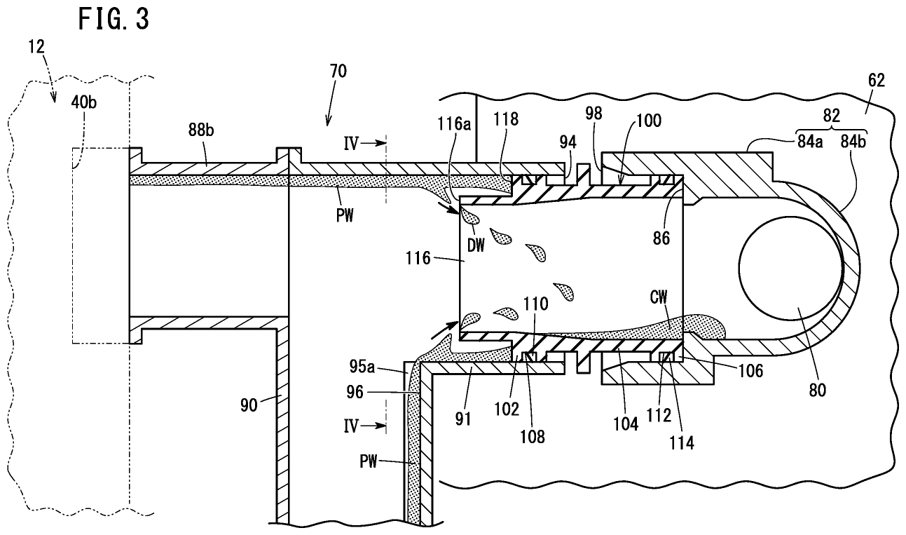

As described above, the first air outlet 40a and the second air outlet 40b (both are gas outlets) are formed in the fuel cell stack 12. On the other hand, an air supply port 80 is formed in the humidifier 62. The humidifier 62 is provided with a gas receiving portion 82. The gas receiving portion 82 has a first portion 84a extending along the left-right direction in FIG. 2 and a second portion 84b covering the air supply port 80. As shown in FIG. 3 which is an enlarged view of a main part of FIG. 2, an annular stopper portion 86 is provided inside the first portion 84a so as to narrow the inside of the first portion 84a. The second portion 84b is bent by approximately 90° with respect to the first portion 84a and extends toward the air supply port 80. As can be understood from this, the gas receiving portion 82 is substantially L-shaped.

The second exhaust manifold 70 has a shape extending from the first air outlet 40a and the second air outlet 40b toward the gas receiving portion 82 (see FIG. 2). To be more specific, the second exhaust manifold 70 includes a first introduction portion 88a connected to the first air outlet 40a, a second introduction portion 88b connected to the second air outlet 40b, and a connector portion 90. In the present embodiment, the first introduction portion 88a is located below the second introduction portion 88b in the direction of gravity, and the connector portion 90 extends vertically.

The first introduction portion 88a and the second introduction portion 88b are individually connected to the connector portion 90. In the connector portion 90, a drain hole 92 is formed in the vicinity of the first introduction portion 88a. A drain tube 93 may be connected to the drain hole 92.

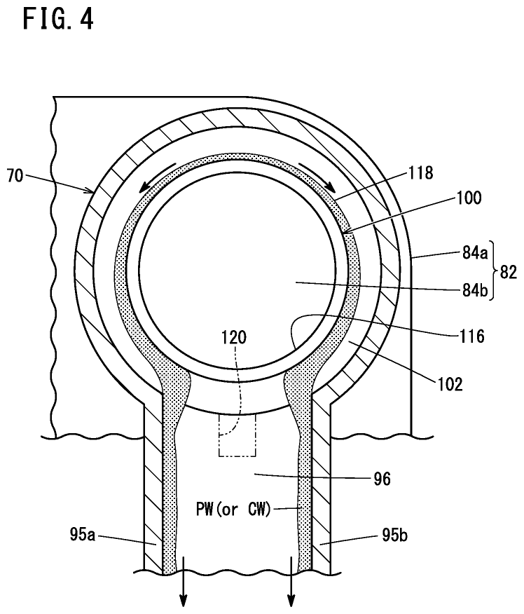

In the connector portion 90, a downstream opening 94 is formed at a position 180° away from the second introduction portion 88b. The connector portion 90 has a connection cylinder 91 in which the downstream opening 94 is formed. The joint tube 100 is inserted into the connection cylinder 91. The connection cylinder 91 surrounds the joint tube 100. The cathode off-gas flowing into the first introduction portion 88a and the second introduction portion 88b flows through the connector portion 90 toward the downstream opening 94. Protruding walls 95a, 95b protruding toward a viewer of FIG. 4 are provided in the vicinity of the downstream opening 94 on the inner wall of the connector portion 90. A guide groove 96 is formed between the protruding wall 95a and the protruding wall 95b. The guide groove 96 is a wide groove extending vertically, which is the extending direction of the connector portion 90. In FIG. 3, only the protruding wall 95a is shown.

As shown in FIG. 3, an upstream opening 98 is formed in the gas receiving portion 82. The upstream opening 98 is positioned downstream of the downstream opening 94 of the second exhaust manifold 70 in the flow direction of the cathode off-gas. However, the upstream opening 98 is positioned upstream of the air supply port 80 in the flow direction of the cathode off-gas. That is, the upstream opening 98 is positioned between the downstream opening 94 of the second exhaust manifold 70 and the air supply port 80 of the humidifier 62.

The second exhaust manifold 70 and the gas receiving portion 82 are connected to each other via the joint tube 100. Here, the joint tube 100 is made of an electrical insulator. It is preferable that the joint tube 100 is an elastic body. In this case, the joint tube 100 is sufficiently compressed when receiving the compressive stress, and easily returns to its original shape when the compressive stress is removed. Preferable specific examples of the material of the joint tube 100 include rubber, elastomer, resin, and the like.

As shown in FIG. 3, the joint tube 100 has an upstream end portion 102, an intermediate portion 104, and a downstream end portion 106. A first annular groove 108 extending along the circumferential direction is formed in the flange-shaped upstream end portion 102 having a slightly larger diameter. A first seal member 110 exhibiting elasticity is mounted in the first annular groove 108. The first seal member 110 seals a gap between an outer circumferential wall of the upstream end portion 102 and an inner wall of the connector portion 90 of the second exhaust manifold 70 in the vicinity of the downstream opening 94.

The slightly larger flanged downstream end portion 106 abuts against the annular stopper portion 86. Thus, the joint tube 100 is positioned relative to the gas receiving portion 82. A second annular groove 112 extending along the circumferential direction is formed in the downstream end portion 106. A second seal member 114 exhibiting elasticity is mounted in the second annular groove 112. The second seal member 114 seals a gap between the outer circumferential wall of the downstream end portion 106 and the inner wall of the gas receiving portion 82 in the vicinity of the upstream opening 98. The outer diameters of the upstream end portion 102 and the downstream end portion 106 are substantially equal to each other.

The joint tube 100 further includes a hollow protrusion 116 protruding from the upstream end portion 102. The protruding direction of the hollow protrusion 116 is the upstream direction in the flow direction of the cathode off-gas. That is, the hollow protrusion 116 is positioned upstream of the upstream end portion 102 (and the first seal member 110) in the flow direction of the cathode off-gas. The outer diameter of the hollow protrusion 116 is smaller than the outer diameter of the upstream end portion 102. Therefore, an annular pocket 118 is formed between the inner wall of the connector portion 90 of the second exhaust manifold 70 and the outer peripheral wall of the hollow protrusion 116.

The outer peripheral portion of the protruded end 116a of the hollow protrusion 116 is spaced apart from the inside wall of the connection cylinder 91 over the entire circumference thereof. The annular pocket 118 is an annular groove recessed from the protruded end 116a of the hollow protrusion 116 toward the downstream end portion 106. The annular pocket 118 opens on the upstream side in the flow direction of the cathode off-gas. One end surface (annular side surface) of the upstream end portion 102 forms a groove bottom of the annular pocket 118.

The inner diameter of the joint tube 100 is smallest at the most upstream hollow protrusion 116 facing the fuel cell stack 12, and gradually increases from the upstream end portion 102 toward the intermediate portion 104. The inner diameter of the joint tube 100 is greatest at the downstream end portion 106 facing the humidifier 62. That is, the inner diameter of the joint tube 100 is small on the upstream side and large on the downstream side. The inner diameter of the hollow protrusion 116 is substantially constant, and the inner diameter of the downstream end portion 106 is also substantially constant.

The fuel cell system 10 according to the present embodiment is basically configured in the manner described above. Next, operations and advantageous effects of the fuel cell system 10 will be described.

When the fuel cell system 10 is assembled, the downstream end portion 106 of the joint tube 100 is inserted into the upstream opening 98 of the gas receiving portion 82 of the humidifier 62 (see FIG. 3). The end surface of the downstream end portion 106 abuts against the annular stopper portion 86 provided inside the gas receiving portion 82. By the abutment, the joint tube 100 is positioned relative to the gas receiving portion 82. On the other hand, the second exhaust manifold 70 is attached to the fuel cell stack 12. Next, the hollow protrusion 116 of the joint tube 100 is inserted into the downstream opening 94 of the connector portion 90 of the second exhaust manifold 70. In this state, the fuel cell stack 12, the second exhaust manifold 70, and the humidifier 62 are positioned and fixed to, for example, the vehicle body of the automobile.

Here, there is a case where a dimension (inner diameter or the like) of the second exhaust manifold 70 or the like is larger than a nominal value within a tolerance range. At this time, the joint tube 100 is slightly compressed due to its elasticity. Therefore, the positions of the coupling portions (bolt holes and the like) of the fuel cell stack 12, the second exhaust manifold 70, and the humidifier 62 can be easily aligned with the positions of the coupling portions (bolt holes and the like) of the vehicle body. Therefore, it is easy to mount the fuel cell system 10 on the vehicle body.

When the fuel cell stack 12 is in operation, hydrogen gas is supplied from the high pressure tank 50 (see FIG. 1). The hydrogen gas passes through the ejector 52 and flows into the first supply manifold 54. The hydrogen gas is distributed in two directions in the first supply manifold 54, and then flows into the first gas flow field 30 from the first hydrogen inlet 34a and the second hydrogen inlet 34b. While flowing through the first gas flow field 30, the hydrogen gas comes into contact with the anode 22 to cause oxidation reactions. The hydrogen gas that has not been used (anode off-gas) contains water and is discharged from the first gas flow field 30 to the first exhaust manifold 56 via the first hydrogen outlet 36a and the second hydrogen outlet 36b.

In the first exhaust manifold 56, the anode off-gas discharged from the first hydrogen outlet 36a and the anode off-gas discharged from the second hydrogen outlet 36b join together. Thereafter, water and hydrogen gas in the anode off-gas are separated in the gas-liquid separator 58. The hydrogen gas from which water has been removed flows to the ejector 52. In the ejector 52, the new hydrogen gas supplied from the high-pressure tank 50 merges with the hydrogen gas discharged from the gas-liquid separator 58. The merged hydrogen gas flows into the first gas flow field 30 through the same path as described above. Thereafter, the above-described circulation is repeated.

On the other hand, compressed air is supplied from the air pump 60. The compressed air flows through the humidifier 62. At this time, the water content of the compressed air is increased. That is, the humidity of the compressed air increases. The compressed air enters the second supply manifold 68 and is distributed in two directions within the second supply manifold 68. Thereafter, the compressed air flows into the second gas flow field 32 from the first air inlet 38a and the second air inlet 38b. While flowing through the second gas flow field 32, oxygen in the compressed air comes into contact with the cathode 24 to cause reduction reactions. In the reduction reactions, water is produced. This water is the produced water PW.

The produced water PW is discharged from the second gas flow field 32 to the second exhaust manifold 70 via the first air outlet 40a or the second air outlet 40b together with the compressed air that has not been used (cathode off-gas). To be more specific, the cathode off-gas and the produced water PW discharged from the first air outlet 40a flow into the connector portion 90 through the first introduction portion 88a shown in FIG. 2. The cathode off-gas and the produced water PW discharged from the second air outlet 40b flow into the connector portion 90 through the second introduction portion 88b shown in FIG. 2. In the connector portion 90, the cathode off-gas discharged from the first air outlet 40a and the cathode off-gas discharged from the second air outlet 40b join together.

The merged cathode off-gas flows into the humidifier 62 via the air supply port 80. In the humidifier 62, when the cathode off-gas passes through the porous membrane (not shown), the compressed air is separated from the produced water PW. That is, the humidity of the compressed air decreases. All or part of the compressed air is returned to the humidifier 62 by the circulation pump 64 (see FIG. 1). On the way, the compressed air merges with new compressed air fed by the air pump 60. The merged compressed air flows into the humidifier 62. At this time, the produced water PW is supplied to the compressed air to increase the water content of the compressed air in the same manner as described above. The compressed air, the water content of which is increased, flows into the second gas flow field 32 through the same path as described above. Thereafter, the above-described circulation is repeated.

Here, the cathode off-gas contains the produced water PW as described above. Therefore, as shown in FIG. 2, the produced water PW flows into the second exhaust manifold 70. Since the cathode off-gas flows toward the air supply port 80, the produced water PW receives pressure from the cathode off-gas in a direction toward the air supply port 80. Therefore, the produced water PW flows toward the downstream opening 94 of the connector portion 90. During the operation of the fuel cell stack 12, the produced water PW is continuously produced as a reaction product at the cathode 24. Therefore, the produced water PW flows along the inner wall of the second exhaust manifold 70 in, for example, a state of continuous stream in a stripe shape or a streak shape.

In the present embodiment, the hollow protrusion 116 of the joint tube 100 is inserted into the downstream opening 94 of the connector portion 90. The outer diameter of the hollow protrusion 116 is smaller than the inner diameter of the connector portion 90. Therefore, the produced water PW flowing along the inner wall of the second exhaust manifold 70 is temporarily retained in the annular pocket 118. When the cathode off-gas comes into contact with the produced water PW in the annular pocket 118, a part of the produced water PW is pushed out from the annular pocket 118 and reaches the opening of the hollow protrusion 116 along the outer wall of the hollow protrusion 116. Then, the cathode off-gas flows into the hollow protrusion 116 through the opening of the hollow protrusion 116, and a part of the produced water PW is blown off into the hollow protrusion 116 by the cathode off-gas. As a result, the produced water PW is partially blown as water droplets DW.

Alternatively, the produced water PW outside the annular pocket 118 is blown off into the hollow protrusion 116 by the cathode off-gas. This also causes the produced water PW to be partially blown as water droplets DW. As described above, a part of the produced water PW enters the hollow protrusion 116 as water droplets DW.

As described above, the inner diameter of the joint tube 100 is smallest at the hollow protrusion 116 located on the most upstream side in the flow direction of the cathode off-gas (the moving direction of the water droplets DW). Therefore, the flow rate of the cathode off-gas increases at the upstream opening of the hollow protrusion 116. That is, a negative pressure is easily generated at the upstream opening of the hollow protrusion 116. As a result, the produced water PW is relatively rapidly sucked into the joint tube 100. Also by this suction, a part of the produced water PW is blown as water droplets DW.

As described above, according to the present embodiment, the continuous flow of the produced water PW is interrupted by the joint tube 100. The joint tube 100 is made of an insulating material. Therefore, the fuel cell stack 12 and the humidifier 62 are electrically insulated from each other. Even when the concentration of the conductive ions contained in the produced water PW is high and the conductivity of the produced water PW is high, electric current is prevented from flowing downstream of the joint tube 100. Thus, it is possible to prevent the electric current from flowing through the humidifier 62, the vehicle body, or the like.

A part of the water droplets DW flows into the humidifier 62 through the air supply port 80. Inside the humidifier 62, the water droplets DW are supplied to the new compressed air supplied from the air pump 60 in the same manner as described above. The remainder of the water droplets DW is accumulated inside the joint tube 100 to form accumulated water CW. When a certain amount or more of water is accumulated as the accumulated water CW, the accumulated water CW flows out from the opening of the hollow protrusion 116 to the connector portion 90. The lowermost end of the air supply port 80 is positioned higher than the lowermost end of the opening of the hollow protrusion 116. Thus, the accumulated water CW is prevented from flowing into the humidifier 62 from the air supply port 80.

On the other hand, a part of the produced water PW retained in the annular pocket 118 flows out from the annular pocket 118 to the connector portion 90. The produced water PW flowing out to the connector portion 90 merges with the accumulated water CW flowing out from the opening of the hollow protrusion 116 to the connector portion 90.

As described above, the guide groove 96 (see FIGS. 2 to 4) is formed in the inner wall of the connector portion 90. The produced water PW and the accumulated water CW flowing out into the connector portion 90 flow downward in the connector portion 90 along the protruding walls 95a and 95b or their vicinities of the guide groove 96, for example. The produced water PW and the accumulated water CW that have flowed downward are discharged to the outside of the second exhaust manifold 70 via the drain hole 92 and the drain tube 93. FIG. 4 does not show the produced water PW rising toward the annular pocket 118.

As shown by an imaginary line in FIG. 4, the inclined groove 120 may be formed by cutting out the inner wall of the connection cylinder 91 and the connector portion 90. In this case, the produced water PW in the annular pocket 118 easily moves to the guide groove 96 along the inclined groove 120.

As described above, the present embodiment discloses the fuel cell system (10) including: the fuel cell stack (12), the device (62) into which the exhaust gas discharged from the fuel cell stack flows, and the pipe (70) connecting the fuel cell stack to the device, wherein the fuel cell stack includes the gas outlet (40a, 40b) from which the exhaust gas flows out, the device includes a gas receiving portion (82) configured to receive the exhaust gas, the pipe extends from the gas outlet toward the gas receiving portion, the joint tube (100) formed of an insulator is interposed between the pipe and the gas receiving portion, the joint tube has the upstream end portion (102) inserted into the downstream opening (94) of the pipe, the seal member (110) is interposed between the joint tube and the pipe and configured to seal a gap between the upstream end portion of the joint tube and the inner wall of the pipe, the joint tube includes the hollow protrusion (116) protruding upstream from the upstream end portion in the flow direction of the exhaust gas and having the outer diameter smaller than the outer diameter of the upstream end portion.

In the joint tube, the hollow protrusion protrudes from the upstream end portion. The upstream end portion is provided with the seal member for sealing the gap between the outer wall of the upstream end portion and the inner wall of the pipe. The outer diameter of the hollow protrusion is smaller than the outer diameter of the upstream end. Thus, the outer wall of the hollow protrusion is spaced apart from the inner wall of the pipe. As a result, the pocket is formed between the outer wall of the hollow projection and the inner wall of the pipe.

In general, water in a pipe flows along an inner wall of the pipe in a state of continuous stream in a stripe shape or a streak shape. Such water flowing in the pipe is blown off from the pipe by the exhaust gas and enters the inside of the hollow protrusion in a state of droplets. Alternatively, the water having entered the pocket is blown away from the end of the outer wall of the hollow protrusion by the exhaust gas. Also at this time, the water enters the inside of the hollow protrusion in the form of droplets.

That is, the water (liquid droplets) entering the inside of the joint tube is separated from the water in the pipe. Therefore, the water in the pipe and the water entering the inside of the joint tube are electrically insulated from each other. Further, the joint tube is an insulator.

For the reasons described above, the fuel cell stack and the predetermined device are prevented from being electrically connected to each other via water. Therefore, even if the conductivity of the produced water becomes high, it is possible to prevent electric current from flowing from the fuel cell stack to the device (humidifier or the like). When the fuel cell system is mounted on a vehicle body of an automobile, electric current is prevented from flowing through the vehicle body.

The present embodiment discloses the fuel cell system in which the inner diameter of the joint tube is smallest at the hollow protrusion and increases toward the downstream side in the flow direction of the exhaust gas.

According to this configuration, the flow velocity of the exhaust gas is increased in the vicinity of the upstream opening of the hollow protrusion. As a result, water is sucked relatively rapidly into the interior of the hollow projection. By the suction, part of the produced water is more easily separated. That is, it becomes easier to electrically insulate the water in the pipe from the water entering the inside of the joint tube.

The present embodiment discloses the fuel cell system in which the drain hole (92) configured to discharge water flowing together with the exhaust gas is formed in the pipe.

Excess water in the pipe is discharged to the outside of the pipe through the drain hole. That is, the excess water that does not flow into the device can be discharged to the outside of the pipe through the drain hole.

The present embodiment discloses the fuel cell system in which the guide groove (96) configured to guide the water to the drain hole is formed in the inner wall of the pipe.

The excess water flows along the guide groove toward the drain hole. That is, the excess water is efficiently guided to the drain hole by the guide groove. Therefore, the excess water can be efficiently discharged to the outside of the pipe.

The present embodiment discloses the fuel cell system in which the joint tube is formed of the elastic body.

The dimensions of the fuel cell stack, the pipe, the device, or the like may be larger than their nominal values within the tolerance. In such a case, the joint tube is slightly compressed due to its elasticity. Therefore, the positions of the coupling portions (bolt holes and the like) of the fuel cell stack, the pipe, and the device can be easily aligned with the positions of the coupling portions (bolt holes and the like) of the target on which the fuel cell system is to be mounted. Therefore, it is easy to mount the fuel cell system on the target on which the fuel cell system is to be mounted. The target on which the fuel cell system is to be mounted is, for example, a vehicle body of an automobile.

In the fuel cell stack, water is produced by reduction reactions at the cathode. That is, the cathode off-gas contains a large amount of the produced water. The cathode off-gas containing the produced water flows into the humidifier. As described above, in the fuel cell system, the cathode off-gas flows from the fuel cell stack to the humidifier. Therefore, in this case, the fuel cell stack and the humidifier are prevented from being electrically connected to each other via the produced water.

As can be understood from this, a specific example of the device is a humidifier. That is, the present embodiment discloses the fuel cell system in which the device is the humidifier (62).

Moreover, the present invention is not limited to the above-described disclosure, and various configurations can be adopted therein without departing from the essence and gist of the present invention.

1. A fuel cell system comprising:
a fuel cell stack,
a device into which an exhaust gas from the fuel cell stack flows, and
a pipe connecting the fuel cell stack to the device,
wherein the fuel cell stack includes a gas outlet from which the exhaust gas flows out,
the device includes a gas receiving portion configured to receive the exhaust gas,
the pipe extends from the gas outlet toward the gas receiving portion,
a joint tube formed of an insulator is interposed between the pipe and the gas receiving portion,
the joint tube has an upstream portion inserted into a downstream opening of the pipe,
a seal member is interposed between the joint tube and the pipe and configured to seal a gap between the upstream portion of the joint tube and an inner wall of the pipe, and
the joint tube includes a hollow protrusion protruding upstream from the upstream portion in a flow direction of the exhaust gas and having an outer diameter smaller than an outer diameter of the upstream portion.

2. The fuel cell system according to claim 1, wherein an inner diameter of the joint tube is smallest at the hollow protrusion and increased toward a downstream side in the flow direction of the exhaust gas.

3. The fuel cell system according to claim 2, further comprising:
a drain hole formed in the pipe and configured to discharge water flowing together with the exhaust gas.

4. The fuel cell system according to claim 3, further comprising:
a guide groove formed in the inner wall of the pipe and configured to guide the water to the drain hole.

5. The fuel cell system according to claim 1, wherein the joint tube is formed of an elastic body.

6. The fuel cell system of claim 1, wherein the device is a humidifier.
